(19) United States
(12) Patent Application Publication
(10) Pub. No.: US 2013/0038192 A1
(43) Pub. Date: Feb. 14, 2013

(54) Damper, Opening/Closing Apparatus and Financial Device Using the Same

(71) Applicants: Woo-Youn Cho, Seoul (KR); Se-Hoon Park, Ansan-si (KR); Jae-Sung Yeon, Seoul (KR); Jang-Wook Choi, Seoul (KR); Kwang-Hun Ko, Bucheon-si (KR)

(72) Inventors: Woo-Youn Cho, Seoul (KR); Se-Hoon Park, Ansan-si (KR); Jae-Sung Yeon, Seoul (KR); Jang-Wook Choi, Seoul (KR); Kwang-Hun Ko, Bucheon-si (KR)

(73) Assignee: LG N-SYS INC., Seoul (KR)

(21) Appl. No.: 13/570,914

(22) Filed: Aug. 9, 2012

(30) Foreign Application Priority Data
Aug. 12, 2011 (KR) 10-2011-0080432

(51) Int. Cl. E05F 5/02; A47B 81/00; E06B 3/36

(52) U.S. Cl. 312/326; 49/381; 16/82

(57) ABSTRACT

Disclosed is a damper and an opening/closing apparatus and a financial device using the same. The damper has first and second bodies mounted on fixed and rotatable objects, respectively, to perform a damping action during an end of the rotation range of opening/closing the rotatable object, abrupt operation of which is thus prevented. The first body has a damping space filled with a damping material and fixed and movable friction plates are installed in the damping space so that the movable friction plate rotates together with a rotation center shaft in a specific range. First and second interlock surfaces are positioned on opposite sides of the rotation center shaft, and first and second interlock stages are formed at a predetermined angle on both stages of the inner surface of a shaft through-hole of the movable friction plate so as to selectively contact the interlock surfaces, respectively.

### CROSS-REFERENCE TO RELATED APPLICATION

This application claims the benefit under 35 U.S.C. §119 of Korean Patent Application No. 10-2011-0080432, filed Aug. 12, 2011, which is hereby incorporated by reference in its entirety.

### BACKGROUND

1. Field of the Invention

The present invention relates to a damper, and an opening/closing apparatus and a financial device using the same.

2. Description of the Prior Art

A door is used to delimit a space from another to selectively allow movement of people or things between them, or completely enclose a space from others for a specific use. More particularly, a door is used to delimit a space inside a building from the outside so that people can enter/exit; when used for a refrigerator, a safe, or a financial device, a door encloses a space, in which specific tasks are conducted.

A hinge is commonly used to install such a door to be able to rotate, and, in order to inhibit the door from being opened/closed abruptly by carelessness or unexpected external force (e.g. wind), a so-called door check is used. Both ends of the door check are supported on the door and the wall, respectively, and the hydraulic pressure is used to inhibit abrupt opening/closing of the door.

However, such a door check has a problem in that, since it is installed on the exterior of a door, it degrades the aesthetic appearance, and its installation requires a lot of space. In order to solve this problem, the rate of door opening/closing is adjusted using a damper containing a damping solution of high viscosity. However, this type of damper has a problem in that it takes a long time to open/close the door, because the damping action occurs throughout the entire process of opening/closing the door.

### BRIEF SUMMARY

Accordingly, the present invention has been made to solve the above-mentioned problems occurring in the prior art, and an object of the present invention is to provide a damper adapted to perform a damping action only in a predetermined range when a door is opened/closed, and an opening/closing apparatus using the same.

In order to accomplish this object, there is provided an opening/closing apparatus including a body; a door connected to the body; and a damper adapted to connect the body and the door and perform damping only in a predetermined range.

The predetermined range is a predetermined angular range defined by the door and the body. The predetermined angular range is a predetermined angular range defined by the door and the body during a process of opening the door from the body. The predetermined angular range is a predetermined angular range defined by the door and the body during a process of closing the door onto the body.

The damper is a hinge adapted to rotatably connect the body and the door.

The damper includes a first body having a damping space open to one side and filled with a damping material; a second body adapted to rotate relative to the first body and provided with a rotation center shaft in a position corresponding to the damping space; a fixed friction plate positioned in the damping material of the damping space and fixedly installed on the first body; and a movable friction plate installed in the damping space so as to face the fixed friction plate and adapted to interlock and rotate with the rotation center shaft only in the partial range.

An interlock portion is positioned on a front end of the rotation center shaft and is positioned in the damping space to interlock with the movable friction plate, and first and second interlock surfaces are formed on both lateral surfaces of the interlock portion, respectively, to selectively contact and interlock with the movable friction plate.

A shaft hole is formed on the second body in a position corresponding to the damping space of the first body, and the rotation center shaft is fixedly inserted into the shaft hole.

The rotation center shaft includes a body portion positioned in the shaft hole of the second body and the damping space of the first body; and an interlock portion extending from the body portion, the interlock portion being installed in the damping space through the fixed friction plate and the movable friction plate, the interlock portion having the first and second interlock surfaces.

In accordance with another aspect of the present invention, there is provided a damper including a first body having a damping space open to one side and filled with a damping material; a second body adapted to rotate relative to the first body and provided with a rotation center shaft in a position corresponding to the damping space; a fixed friction plate positioned in the damping material of the damping space and fixedly installed on the first body; and a movable friction plate installed in the damping space so as to face the fixed friction plate and adapted to interlock and rotate with the rotation center shaft only in a partial range.

An interlock portion is provided on a front end of the rotation center shaft and is positioned in the damping space to interlock with the movable friction plate, and first and second interlock surfaces are formed on both lateral surfaces of the interlock portion, respectively, to selectively contact and interlock with the movable friction plate.

In accordance with another aspect of the present invention, there is provided a financial device including a cabinet having a predetermined inner space open to a surface and having a portion positioned on a different surface to be operated by a customer; a door installed on the cabinet to open/close an open portion of the inner space; and a damper adapted to connect the cabinet and the door and perform damping only in a predetermined range.

The predetermined range is a predetermined angular range defined by the door and the cabinet. The predetermined angular range is a predetermined angular range defined by the door and the cabinet during a process of opening the door from the cabinet. The predetermined angular range is a predetermined angular range defined by the door and the cabinet during a process of closing the door onto the cabinet.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view illustrating a damper according to an embodiment of the present invention;

FIG. 2 is a partially-broken perspective view illustrating a damper according to an embodiment of the present invention;

FIG. 3 is a perspective view illustrating the lower construction of a second connection member constituting an embodiment of the present invention;

FIG. 4 is a perspective view illustrating the construction of a rotation center shaft constituting an embodiment of the present invention;

FIG. 5 is a top view illustrating the construction of a movable friction plate constituting an embodiment of the present invention;

FIGS. 6a-6c illustrate successive operations/states of a door, which uses a damper according to an embodiment of the present invention, during a process of opening the door;

FIGS. 7a-7c illustrate successive operations/states of a door, which uses a damper according to an embodiment of the present invention, during a process of closing the door; and

FIG. 8 is a perspective view illustrating major components of a financial device having a door opened/closed by an opening/closing apparatus according to an embodiment of the present invention.

### DETAILED DESCRIPTION

Hereinafter, exemplary embodiments of the present disclosure will be described with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

A financial device according to embodiments is a device that performs financial businesses, i.e., medium processing including processing such as deposit processing, giro receipt, or gift certificate exchange and/or processing such as withdrawal processing, giro dispensing, or gift certificate dispensing by receiving various media such as, e.g., paper moneys, bills, giros, coins, gift certificates, etc. For example, the financial device may comprise an automatic teller machine (ATM) such as a cash dispenser (CD) or a cash recycling device. However, the financial device is not limited to the above-described examples. For example, the financial device may be a device for automatically performing the financial businesses such as a financial information system (FIS).

Hereinafter, assuming that the financial device is the ATM, an embodiment will be described. However, this assumption is merely for convenience of description, and technical idea of the present disclosure is not limited to the ATM.

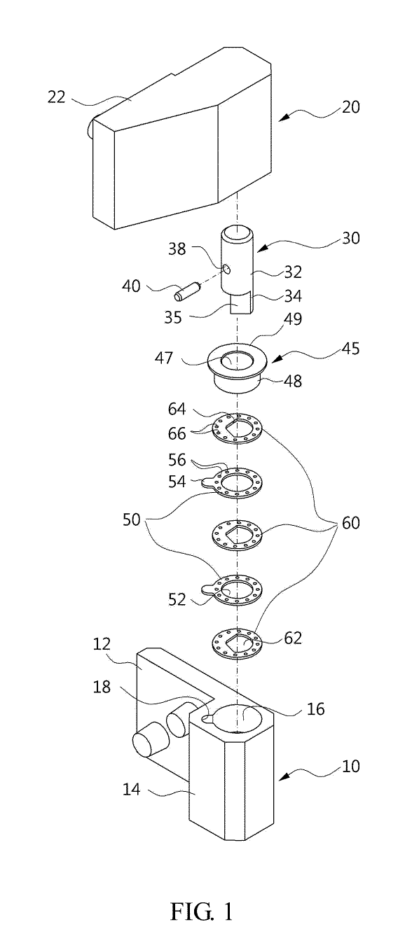

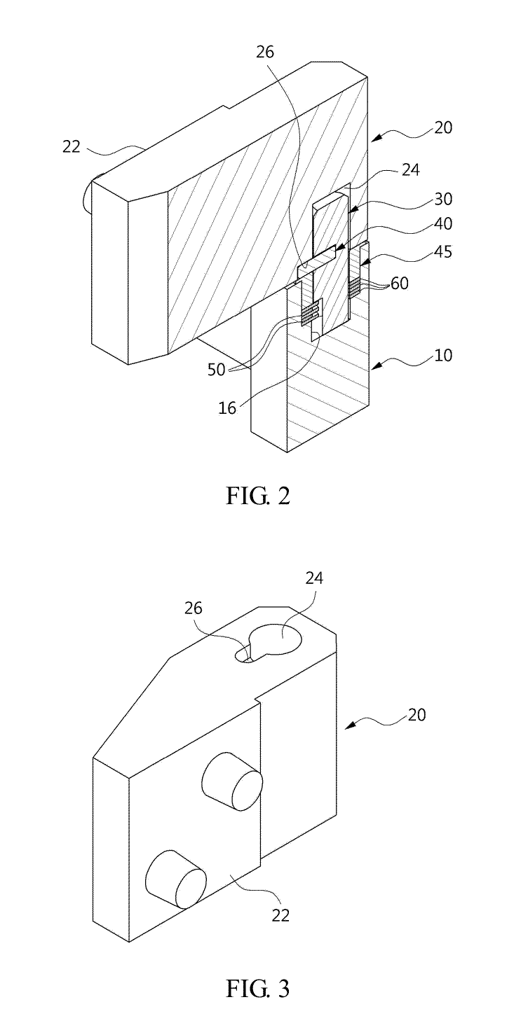

As shown in FIG. 1, the present invention includes a first body 10 having a damping space 16 open to one side and filled with a damping material; a second body 20 adapted to rotate relative to the first body 10 and provided with a rotation center shaft 30 in a position corresponding to the damping space 16; a fixed friction plate 50 positioned in the damping material of the damping space 16 and fixedly installed on the first body 10; and a movable friction plate 60 installed in the damping space 16 to face the fixed friction plate 50 and adapted to interlock and rotate with an interlock portion 34 of the rotation center shaft 30 only in a predetermined range.

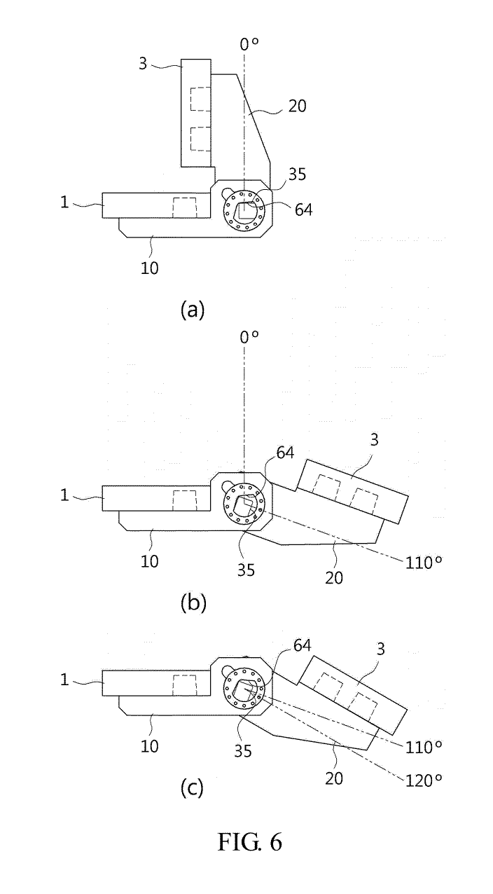

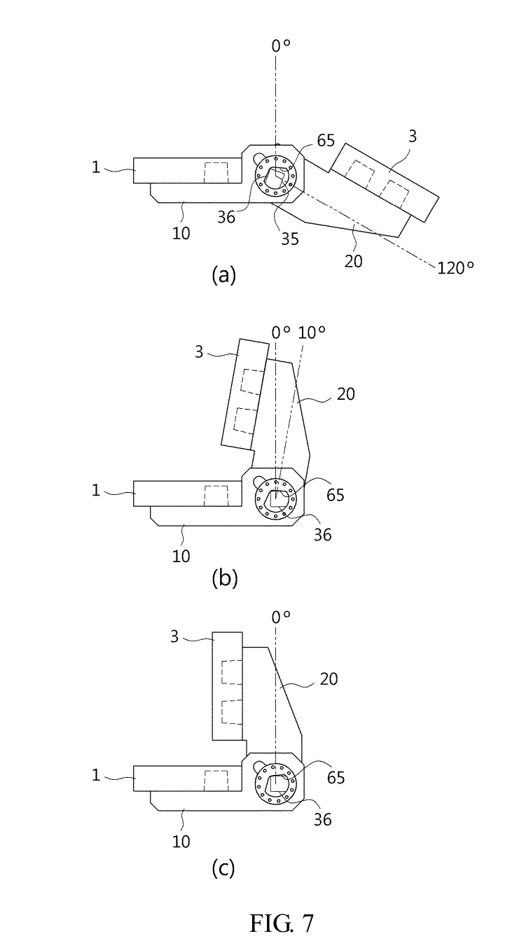

Components for the above-mentioned construction will now be described in detail. The first and second bodies 10 and 20 define the contour of a damper. The first body 10 is, as shown in FIGS. 6 and 7, mounted on a fixed object 1, and the second body 20 is mounted on a rotatable object 3. It is also possible to mount the first body 10 on the rotatable object 3 and mount the second body 20 on the fixed object 1. The first and second bodies 10 and 20, according to their shape, can either define the contour of a damper or constitute a hinge for rotatably supporting a door.

In the illustrated embodiment, the first and second bodies 10 and 20 are mounted to fixed and rotatable objects 1 and 3, respectively, to constitute a kind of hinge so that the rotatable object 3 can rotate with regard to the fixed object 1 to perform opening/closing operations. It is also possible to vary the shape of the first and second bodies 10 and 20 to be used as a damper for adjusting the rate of rotation of the rotatable object 3.

The first body 10 is provided with a mounting plate portion 12 to be mounted on the fixed object 1. The mounting plate portion 12 has the shape of a plate so that it can be mounted and fixed to one side of the fixed object 1.

The first body 10 has a housing portion 14 on one side thereof. The housing portion 14 has an approximately cylindrical shape, and its interior is open only through one end. A damping space 16 is defined in the housing portion 14. It is recommended that the damping space 16 has a cylindrical shape. However, the housing portion 14 and the damping space 16 do not necessarily have cylindrical shapes.

A fixing recess 18 is formed on the inner surface of the damping space 16. The fixing recess 18 extends from the entrance towards the interior to be elongated on the inner surface of the damping space 16. A fixing protrusion 54 of the fixed friction plate 50 and a fixing protrusion (not shown) of a bearing 45, which will be described later, are fixedly positioned in the fixing recess 18.

The second body 20 has a mounting plate portion 22 formed on one side in the shape of a plate. The mounting plate portion 22 is fixedly mounted on one side of the rotatable object 3. Various structures can be employed to fixedly mount the first and second bodies 10 and 20 onto the fixed and rotatable objects 1 and 3, respectively, such as bolts or screws.

A shaft hole 24 is formed on the second body 20 in a position corresponding to the damping space 16, which is formed on the housing portion 14 of the first body 10, as clearly shown in FIG. 3. One side of the rotation center shaft 30 (described later) is inserted and positioned in the shaft hole 24. A fixing pin recess 26 is indented from the inner surface of the shaft hole 24. A fixing pin 40 (described later) is positioned in the fixing pin recess 26 so that the second body 20 and the rotation center shaft 30 rotate integrally.

A rotation center shaft 30 is provided to be inserted and installed into the damping space 16 of the first body 10 and the shaft hole 24 of the second body 20. The rotation center shaft 30 serves as a center of rotation of the rotatable object 3. The rotation center shaft 30, according to the present embodiment, rotates relative to the first body 10 and rotates integrally with the second body 20.

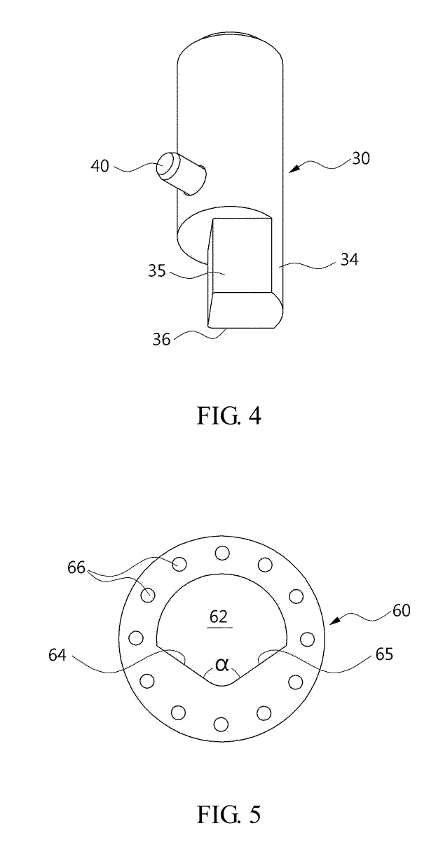

The rotation center shaft 30 includes a cylindrical body portion 32 and an interlock portion 34 having a diameter smaller than that of the body portion 32. The interlock portion 34 has, as clearly shown in FIG. 4, first and second interlock surfaces 35 and 36 formed on both sides, respectively. The first and second interlock surfaces 35 and 36, with reference to a top view of the body portion 32 of the rotation center shaft 30, are positioned on portions corresponding to inner sides of the cross range of the body portion 32. This configuration is shown in FIGS. 6 and 7. The first and second interlock surfaces 35 and 36 are adapted to cause the movable friction plate 60 (described later) to interlock with the rotation center shaft 30 in a predetermined range. A part of the body portion 32 and the interlock portion 34 of the rotation center shaft 30 are positioned in the damping space 16.

The interlock portion 34 of the rotation center shaft 30 is positioned in the damping space 16 through the fixed friction plate 50 and the movable friction plate 60 (described later). The first and second interlock surfaces 35 and 36 of the interlock portion 34 are adapted to selectively contact first and second interlock stages 64 and 65 of the movable friction plate 60 (described later) and rotate the movable friction plate 60.

A fixing hole 38 is formed on one side of the outer surface of the body portion 32 of the rotation center shaft 30. The position of the fixing hole 38 coincides with the fixing pin recess 26 when the rotation center shaft 30 is inserted into the shaft hole 24. One end of the fixing pin 40 (described later) is fitted into the fixing hole 38.

In order to guarantee that the rotation center shaft 30 operate integrally with the rotatable object 3, one end of the fixing pin 40 is inserted into the fixing hole 38 of the rotation center shaft 30. The part of the fixing pin 40, which protrudes out of the rotation center shaft 30, is positioned in the fixing pin recess 26 of the second body 20. For reference, the rotation center shaft 30 may be formed integrally on the second body 20. In other words, the rotation center shaft 30 is integral with the second body 20, and the interlock portion 34 is formed on the protruding front end.

Meanwhile, a bearing 45 is installed at the entrance of the damping space 16 of the first body 10. The bearing 45 has a shaft through-hole 47 formed through its center so that the body portion 32 of the rotation center shaft 30 can pass. The bearing 45 is adapted to support the rotation center shaft 30 so as to rotate smoothly, as well as seal the damping space 16 from the outside. To this end, the bearing 45 has a cylindrical body portion 48 fastened along the inside of the entrance of the damping space 16 and adapted to support the rotation center shaft 30 so that the inner surface can rotate; and a cap portion 49 of a ring shape positioned on the upper end of the body portion 48 and seated on the periphery of the entrance of the damping space 16. The body portion 48 is press-fitted onto the inner surface of the damping space 16 to inhibit any leakage of a damping material from the damping space 16.

The damping space 16 is filled with a damping material (given no reference numeral). Examples of the damping material include a fluid (e.g. silicon oil), solid powder, etc. A fluid having at least a predetermined level of viscosity is generally used as the damping material.

At least one fixed friction plate 50 is installed in the damping space 16. The fixed friction plate 50 has an approximately circular plate shape. However, the fixed friction plate 50 has only to have the same shape as the cross range of the interior of the damping space 16, or smaller than it.

The fixed friction plate 50 has a shaft through-hole 52 formed so that the interlock portion 34 of the rotation center shaft 30 can pass. The shaft through-hole 52 has a diameter smaller than that of the body portion 32 of the rotation center shaft 30 and a shape enabling free rotation of the interlock portion 34. In the illustrated embodiment, the shaft through-hole 52 has a circular shape.

A fixing protrusion 54 protrudes from one side of the periphery of the fixed friction plate 50 so as to be seated on and engaged with the fixing recess 18 of the damping space 16. The fixing protrusion 54 is formed in a position corresponding to the fixing recess 18. Although there is only one fixing protrusion 54 in the illustrated embodiment, each fixed friction plate 50 may have a number of fixing protrusions 54. In this case, fixing recesses 18 are formed to correspond to respective positions of the fixing protrusions 54. Such positioning of the fixing protrusion 54 in the fixing recess 18 maintains the fixed friction plate 50 fixed in the damping space 16.

A number of passage holes 56 are formed on the fixed friction plate 50. The damping material passes through the passage holes 56. Although the passage holes 56 are arranged along a circle around the fixed friction plate 50 in the illustrated embodiment, other types of arrangement of passage holes 56 are also possible.

Movable friction plates 60 are positioned in the damping space 16 so as to alternate with the fixed friction plates 50. In the present embodiment, three movable friction plates 60 and two fixed friction plates 50 alternate with each other. The movable friction plates 60 are adapted to move integrally with the rotation center shaft 30 in a predetermined range. When the movable friction plates 60 rotate while facing the fixed friction plates 50, the damping material between them hinders the rotation of the movable friction plates 60 and decreases the rate of rotation of the rotation center shaft 30.

Although the movable friction plates 60 also have circular plate shapes in the present embodiment, any shape is possible as long as they can rotate in the damping space 16. However, the same shape between the movable friction plates 60 and the fixed friction plates 50 is highly recommended for a better damping action. Each movable friction plate 60 has a shaft through-hole 62 formed through its center so that the interlock portion 34 of the rotation center shaft 30 passes through it. The shaft through-hole 62 has first and second interlock stages 64 and 65 formed to correspond to the first and second interlock surfaces 35 and 36 of the interlock portion 34. The existence of the first and second interlock stages 64 and 65 gives the shaft through-hole 62 an approximately fan-shaped configuration as a whole. The first and second interlock stages 64 and 65 are adapted to selectively contact the first and second interlock surfaces 35 and 36 and rotate the movable friction plates 60. The movable friction plates 60 also have a number of passage holes 66 so that the damping material can pass.

The interlock portion 34 of the rotation center shaft 30 rotates freely in the intermediate range, in which the first and second interlock stages 64 and 65 define a predetermined angle, and it is not until the interlock stages 64 and 65 contact the interlock surfaces 35 and 36 that the movable friction plates 60 begin rotating. As such, the damping material exhibits a damping action in the range in which the interlock stages 64 and 65 are forced against the interlock surfaces 35 and 36, and in which the movable friction plates 60 rotate together, and decreases the rate of rotation of the second body 20.

This means that the design of the angle between the first and second interlock stages 64 and 65 and the angle between the interlock surfaces 35 and 36 determines the range in which rotation of the rotation center shaft 30 is subjected to a damping action. In the illustrated embodiment, the first and second interlock surfaces 35 and 36 on both surfaces of the interlock portion 34 of the rotation center shaft 30 move between the first and second interlock stages 64 and 65, which define a predetermined angle between them. As a result, damping occurs in a range in which the first interlock surface 35 and the first interlock stage 64 contact each other, following rotation of the rotation center shaft 30 in a direction, and in which the rotation center shaft 30 rotates together with the movable friction plates 60, as well as in a range in which the second interlock stage 65 contacts the second interlock surface 34, and in which the rotation center shaft 30 rotates together with the movable friction plates 60.

The construction of an opening/closing apparatus using the above-described damper will now be described. FIGS. 6 and 7 illustrate the construction and operational state of the opening/closing apparatus. For reference, in FIG. 6, the fixed object 1 may correspond to the body of the opening/closing apparatus, and the rotatable object 3 to a door.

The opening/closing apparatus according to the present embodiment includes a body, i.e. fixed object 1; a door, i.e. rotatable object 3, which is connected to the body; and a damper adapted to connect the body (fixed object 1) and the door (rotatable object 3) and perform damping only in a predetermined range. The damper, in this case, is a hinge adapted to rotatably connect the fixed object 1 and the rotatable object 3. The predetermined range, as used herein, refers to a predetermined angular range defined by the rotatable object 3 and the fixed object 1 (body). Specifically, the predetermined angular range includes a predetermined angular range defined by the rotatable object 3 and the fixed object 1 during a process of opening the rotatable object 3 from the fixed object 1 (body) and a predetermined angular range defined by the rotatable object 3 and the fixed object 1 during a process of closing the rotatable object 3 to the fixed object 1. The predetermined angular range corresponds to a predetermined partial range during a process of opening/closing the rotatable object 3, and it is recommended that the predetermined angular range is an end of the rotation range.

The construction of the damper has already been described: the first body 10 is fixed to the fixed object 1, the second body 20 is fixed to the rotatable object 3; and the rotation center shaft 30 of the second body 20 rotates in the damping space 16 of the first body 10 and rotates the movable friction plates 60 only in a predetermined range with regard to the fixed friction plates 50, thereby causing a damping action.

The operation of the damper in an opening/closing apparatus, which has the above-mentioned construction, will now be described in detail with reference to FIGS. 6 and 7. It will be assumed in the present embodiment that, when the rotatable object 3 is forced against the fixed object 1 (i.e. when the rotatable object 3 has not yet rotated), it is at 0°; and, when the rotatable object 3 is fully opened, it has rotated as much as 120°. And damping occurs in the range between 110° and 120° when the rotatable object 3 is opened, and in the range between 10° and 0° when it is closed.

FIG. 6 illustrates a series of processes of opening the door (assuming the rotatable object 3 as the door) from a closed state. In FIG. 6(a), the first and second bodies 10 and 20 are positioned perpendicular to each other, and the first interlock surface 35 of the rotation center shaft 30 contacts the first interlock stage 64 of the movable friction plate 60. In other words, the rotatable object 3 is at 0°.

Clockwise (with reference to the drawings) rotation of the rotatable object 3 causes the rotatable object 3, the second body 20, and the rotation center shaft 30 to rotate together. However, the interlock portion 34 of the rotation center shaft 30 rotates in the shaft through-holes 52 and 62 of the fixed and movable friction plates 50 and 60. The interlock portion 34 keeps rotating until the second interlock surface 36 contacts the second interlock stage 65 of the movable friction plate 60. FIG. 6(b) shows the second interlock surface 36 of the interlock portion 34 contacting the second interlock stage 65. The angle of rotation of the rotation center shaft 30 is 110°, which is the same as the angle between the first and second interlock stages 64 and 65 of the movable friction plate 60.

Once the second interlock surface 34 contacts the second interlock stage 65, the movable friction plate 60 rotates together with the rotation center shaft 30. The movable friction plate 60 needs to overcome the viscosity of the damping material, in order to rotate inside the damping material, and thus hinders the rotation of the rotation center shaft 30. FIG. 6(c) shows a range in which the rotation center shaft 30 and the movable friction plate 60 operate integrally; in that range, the damping material absorbs rotational force of the rotatable object 3 and inhibits abrupt opening of the rotatable object 3. In this case, the rotatable object 3 is rotated in the range between 110° and 120°.

FIG. 7 illustrates a series of processes of closing the rotatable object 3, which has been opened. The second interlock surface 36 of the rotation center shaft 30 is initially contacting the second interlock stage 65 of the movable friction plate 60, i.e. the rotatable object 3 is fully opened. Then, force is applied in such a direction that the rotatable object 3 is closed, and the rotatable object 3 is thus rotated in the closing direction. Rotational force of the rotatable object 3 is absorbed by the viscosity of the damping material, which is applied to the interlock portion 34 itself of the rotation center shaft 30, until the first interlock surface 35 of the interlock portion 34 of the rotation center shaft 30 contacts the first interlock stage 64 of the rotatable friction plate 60.

However, a damping action by the damping material occurs when the first interlock surface 35 of the interlock portion 34 of the rotation center shaft 30 contacts the first interlock stage 64, and when the rotational friction plate 60 begins to rotate together with the rotation center shaft 30. That is, until the position shown in FIG. 7(b) is reached, the rotation center shaft 30 rotates from 120° point to 10° point (i.e. as much as 110°) separate from the rotational friction plate 60. The rotation center shaft 30 and the rotatable friction plate 60 rotate together, until the state shown in FIG. 7(c) is reached, and a damping action by the damping material is generated by the rotatable friction plate 60. As a result, the rate of rotation of the rotatable object 3 decreases abruptly in the end of the rotation of the rotatable object 3.

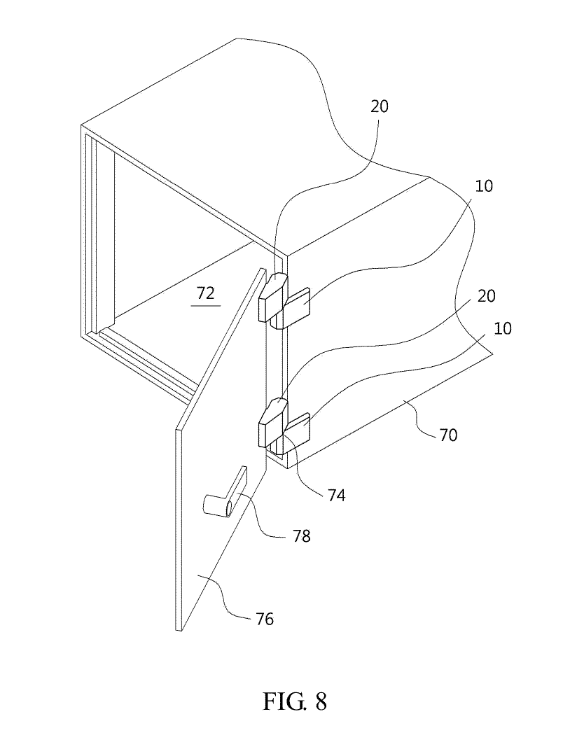

FIG. 8 illustrates major components of a financial device employing an opening/closing apparatus using an above described damper.

In the drawing, the contour of the financial device is shown, and illustration and explanation of the internal construction will be omitted for convenience. A cabinet 70 (i.e. body) defines the contour and framework of the financial device, and an inner space 72 is formed therein so that various components of the financial device are installed. The inner space 72 is open to the back surface of the cabinet 70. The front surface of the cabinet 70 is not visible in FIG. 8, and has a configuration for enabling customers to manipulate the financial device and process media. The configuration for enabling customers to manipulate the financial device and process media can also be positioned on a different outer surface, to which the inner space 72 is not open.

A door 76 is installed on the back surface of the cabinet 70 by a hinge 74 so as to be rotated and opened/closed. The damper, the construction of which has been described with reference to FIG. 1, is used as the hinge 74. Therefore, the rate of rotation of the door 76 is controlled by the hinge 74. Specifically, a damping action occurs in the end of the rotation range of opening/closing the door 76 and adjusts the rate of opening/closing of the door 76, which is inhibited from shocking the cabinet 70.

The damper, in this case, is a hinge adapted to rotatably connect the cabinet 70 and the door 76 and perform damping only in a predetermined range. As used herein, the predetermined range refers to a predetermined angular range defined by the door 76 and the cabinet 70 (body). Specifically, the predetermined angular range includes a predetermined angular range defined by the door 76 and the cabinet 70 during a process of opening the door 76 from the cabinet 70 (body) and a predetermined angular range defined by the door 76 and the cabinet 70 during a process of closing the door 76 to the cabinet 70. The predetermined angular range corresponds to a predetermined partial range during a process of opening/closing the door 76, and it is recommended that the predetermined angular range is an end of the rotation range.

The construction of the damper has already been described: the rotation center shaft 30 of the second body 20 rotates in the damping space 16 of the first body 10 and rotates the movable friction plates 60 only in a predetermined angular range with regard to the fixed friction plates 50, thereby causing a damping action.

Even though all the elements of the embodiments are coupled into one or operated in the combined state, the present disclosure is not limited to such an embodiment. That is, all the elements may be selectively combined with each other without departing the scope of the invention. Furthermore, when it is described that one comprises (or includes or has) some elements, it should be understood that it may comprise (or include or has) only those elements, or it may comprise (or include or have) other elements as well as those elements if there is no specific limitation. Unless otherwise specifically defined herein, all terms including technical or scientific terms are to be given meanings understood by those skilled in the art. Like terms defined in dictionaries, generally used terms needs to be construed as meaning used in technical contexts and are not construed as ideal or excessively formal meanings unless otherwise clearly defined herein.

Although embodiments have been described with reference to a number of illustrative embodiments thereof, it will be understood by those skilled in the art that various changes in form and details may be made therein without departing from the spirit and scope of the invention as defined by the appended claims. Therefore, the preferred embodiments should be considered in descriptive sense only and not for purposes of limitation, and also the technical scope of the invention is not limited to the embodiments. Furthermore, is defined not by the detailed description of the invention but by the appended claims, and all differences within the scope will be construed as being comprised in the present disclosure.

What is claimed is:

1. An opening/closing apparatus comprising:
a body;
a door connected to the body; and
a damper adapted to connect the body and the door and perform damping only in a predetermined range.

2. The opening/closing apparatus as claimed in claim 1, wherein the predetermined range is a predetermined angular range defined by the door and the body.

3. The opening/closing apparatus as claimed in claim 2, wherein the predetermined angular range is a predetermined angular range defined by the door and the body during a process of opening the door from the body.

4. The opening/closing apparatus as claimed in claim 2, wherein the predetermined angular range is a predetermined angular range defined by the door and the body during a process of closing the door onto the body.

5. The opening/closing apparatus as claimed in claim 1, wherein the damper is a hinge adapted to rotatably connect the body and the door.

6. The opening/closing apparatus as claimed in claim 1, wherein the damper comprises:
a first body having a damping space open to one side and filled with a damping material;
a second body adapted to rotate relative to the first body and provided with a rotation center shaft in a position corresponding to the damping space;
a fixed friction plate positioned in the damping material of the damping space and fixedly installed on the first body; and
a movable friction plate installed in the damping space so as to face the fixed friction plate and adapted to interlock and rotate with the rotation center shaft only in the partial range.

7. The opening/closing apparatus as claimed in claim 6, wherein an interlock portion is positioned on a front end of the rotation center shaft and is positioned in the damping space to interlock with the movable friction plate, and first and second interlock surfaces are formed on both lateral surfaces of the interlock portion, respectively, to selectively contact and interlock with the movable friction plate.

8. The opening/closing apparatus as claimed in claim 7, wherein a shaft hole is formed on the second body in a position corresponding to the damping space of the first body, and the rotation center shaft is fixedly inserted into the shaft hole.

9. The opening/closing apparatus as claimed in claim 8, wherein the rotation center shaft comprises:
a body portion positioned in the shaft hole of the second body and the damping space of the first body; and
an interlock portion extending from the body portion, the interlock portion being installed in the damping space through the fixed friction plate and the movable friction plate, the interlock portion having the first and second interlock surfaces.

10. The opening/closing apparatus as claimed in claim 9, wherein shaft through-holes are formed on the fixed friction plate and the movable friction plate, respectively, so that the rotation center shaft can pass; first and second interlock stages are formed on an inner surface of the shaft through-hole of the movable friction plate so as to have a predetermined angle and are adapted to selectively contact the first and second interlock surfaces of the interlock portion, respectively; and the first interlock stage and the first interlock surface and the second interlock stage and the second interlock surface are adapted to selectively contact each other during an end of the rotation range of the rotation center shaft in a direction and during an end of the rotation range in a different direction, respectively.

11. The opening/closing apparatus as claimed in claim 10, wherein a number of passage holes are formed on the fixed friction plate and the movable friction plate so that the damping material can pass.

12. The opening/closing apparatus as claimed in claim 11, wherein a bearing is installed at an entrance of the damping space to rotatably support the rotation center shaft and seal the damping space.

13. The opening/closing apparatus as claimed in claim 6, wherein the first and second bodies have mounting plate portions to be mounted on fixed and rotatable objects, respectively.

14. The opening/closing apparatus as claimed in claim 13, wherein the first body has a housing portion formed on one side of the mounting plate portion so that the damping space is formed inside the housing portion.

15. A damper comprising:
a first body having a damping space open to one side and filled with a damping material;
a second body adapted to rotate relative to the first body and provided with a rotation center shaft in a position corresponding to the damping space;
a fixed friction plate positioned in the damping material of the damping space and fixedly installed on the first body; and
a movable friction plate installed in the damping space so as to face the fixed friction plate and adapted to interlock and rotate with the rotation center shaft only in a partial range.

16. The damper as claimed in claim 15, wherein an interlock portion is provided on a front end of the rotation center shaft and is positioned in the damping space to interlock with the movable friction plate, and first and second interlock surfaces are formed on both lateral surfaces of the interlock portion, respectively, to selectively contact and interlock with the movable friction plate.

17. A financial device comprising:
a cabinet having a predetermined inner space open to a surface and having a portion positioned on a different surface to be operated by a customer;
a door installed on the cabinet to open/close an open portion of the inner space; and
a damper adapted to connect the cabinet and the door and perform damping only in a predetermined range.

18. The financial device as claimed in claim 17, wherein the predetermined range is a predetermined angular range defined by the door and the cabinet.

19. The financial device as claimed in claim 18, wherein the predetermined angular range is a predetermined angular range defined by the door and the cabinet during a process of opening the door from the cabinet.

20. The financial device as claimed in claim 18, wherein the predetermined angular range is a predetermined angular range defined by the door and the cabinet during a process of closing the door onto the cabinet.
